(19) United States
(12) Patent Application Publication
(10) Pub. No.: US 2019/0016206 A1
(43) Pub. Date: Jan. 17, 2019

(54) Water Gravity Loop Power ARA EV (WGLPARAEV)

(71) Applicant: Oscar Edgardo Moncada Rodriguez, Raleigh, NC (US)

(72) Inventor: Oscar Edgardo Moncada Rodriguez, Raleigh, NC (US)

(21) Appl. No.: 15/648,388

(22) Filed: Jul. 12, 2017

(51) Int. Cl. B60K 6/00

(52) U.S. Cl. CPC B60K 6/00; F03B 17/005

(57) ABSTRACT

A high efficiency Transportation Electric Vehicles that are primarily propelled by an electric motor that is powered by the Water Gravity Loop Power Plant (WGLPP), and secondarily powered by my innovation the Accelerated Ram Air (ARA-ICT) that continuously generates increasing thrust as the vehicle accelerates or maintain its acceleration given a constant Vehicle speed (Newton's 2^{nd} and 3^{rd} Laws and Bernoulli's principle).

### BACKGROUND

My research of the Transportation Industry in the U.S. reveled that “Freight transportation is carried by a variety of networks. The largest percentage of US freight is carried by trucks (60%), followed by pipelines (18%), rail (10%), ship (8%), and air (0.01%)” Wikipedia.

Furthermore, the American Trucking Associations (ATA) published in their Report, Trends, and Statistics section webpage “The trucking industry is the lifeblood of the U.S. economy. Over 70% of all the freight tonnage moved in the U.S. goes on trucks . . . To move 10.5 billion tons of freight annually requires over 3.4 million heavy-duty Class 8 trucks and over 3.5 million truck drivers. It also takes over 38 billion gallons of diesel fuel to move all of that freight. Simply—without trucks, America stops.”

The facts above describe the great need by the US Trucking Industry for a highly efficient, heavy duty, continuous, and renewable energy transportation technology. A requirement of 38 billion gallons of diesel causes a tremendous environmental impact during its production and consumption. To aggravate the problem the dependency on fossil fuels is a continuously growing problem given the limited amount of fossil fuels. These facts validates the urgent need for a new transportation technology that is renewable, heavy duty, sustainable, environmentally friendly, resilient, and continuous.

### BRIEF SUMMARY

The Water Gravity Loop ARA Electric Vehicle (WGLPARAEV) is an innovative renewable energy technology to solve and mitigate the problems described above. This application for my invention relates to high efficiency Transportation Electric Vehicles that are primarily propelled by an electric motor that is driven by electricity generated by the Water Gravity Loop Power Plant (WGLPP), and secondarily powered by my innovation the Accelerated Ram Air (ARA-ICT) that continuously generates increasing thrust as the vehicle accelerates or maintain its acceleration given a constant Vehicle speed (Newton's 2^{nd} and 3^{rd} Laws and Bernoulli's principle), and also can be integrated with Vehicles that are powered by fossil fuels or Electricity to improve their efficiency.

### BRIEF DESCRIPTION OF THE DRAWINGS

FIG. 1 Truck Vehicle—Left Side View

The drawing describes an aerodynamically efficient design aimed to reduce drag, lift, and maximize the intake of the Ram Air to convert it to thrust.

FIG. 2 Truck Vehicle—Front View

The drawing describes the Ram Air Intake and the other features of the vehicle.

FIG. 3 Accelerated Ram Air (ARA-ICT) Sections

The drawing describes the ARA-ICT Sections Intake, Compression, Thrust, and Nozzle.

FIG. 4 Chassis

The drawing describes the main Chassis (Rolling Chassis), the Supports (Sub-chassis) for the ARA-ICT, the WGLPP, and the Firewall Support.

FIG. 5 Interior Layout

The drawing describes the five interior sections: 1. Control Section. 2. Sleeping Section. 3. WGLPP Section. 4. ARA-ICT Section. 5. Accessories Section.

### DETAILED DESCRIPTION OF THE INVENTION

My invention relates to a high efficiency Transportation Electric Vehicles that are primarily propelled by an electric motor that is powered by the Water Gravity Loop Power Plant (WGLPP), my U.S. Pat. No. 9,677, 536 B2, and secondarily powered by my innovation the Accelerated Ram Air (ARA-ICT) or the Liquid-ICT that continuously generates increasing thrust as the vehicle accelerates or maintain its acceleration given a constant Vehicle speed (Newton's 2^{nd} and 3^{rd} Laws and Bernoulli's principle). The ARA-ICT can also be integrated with Vehicles that are powered by fossil fuels or Electricity to improve their efficiency. Transportation Electrical Vehicles includes trucks, buses, motorhomes, trains, and any other applicable EV.

### External Description

The Transportation Vehicles will be aerodynamically designed to generate the minimum drag, generate the minimum lift, and maximize the intake of RAM air to be accelerated by the Accelerated Ram Air—Intake, Compression, and Thrust (ARA-ICT). The Vehicles will be a Body-on-Frame construction and will be built using a combination of Carbon Fibers, Glass Fibers, Plastic Fibers, Steel, Aluminum, Titanium, Kevlar, other required materials, and a highly efficient lighting systems. The Vehicle specifications should meet the USDOT regulations, or the laws of the applicable country and the customer requirements.

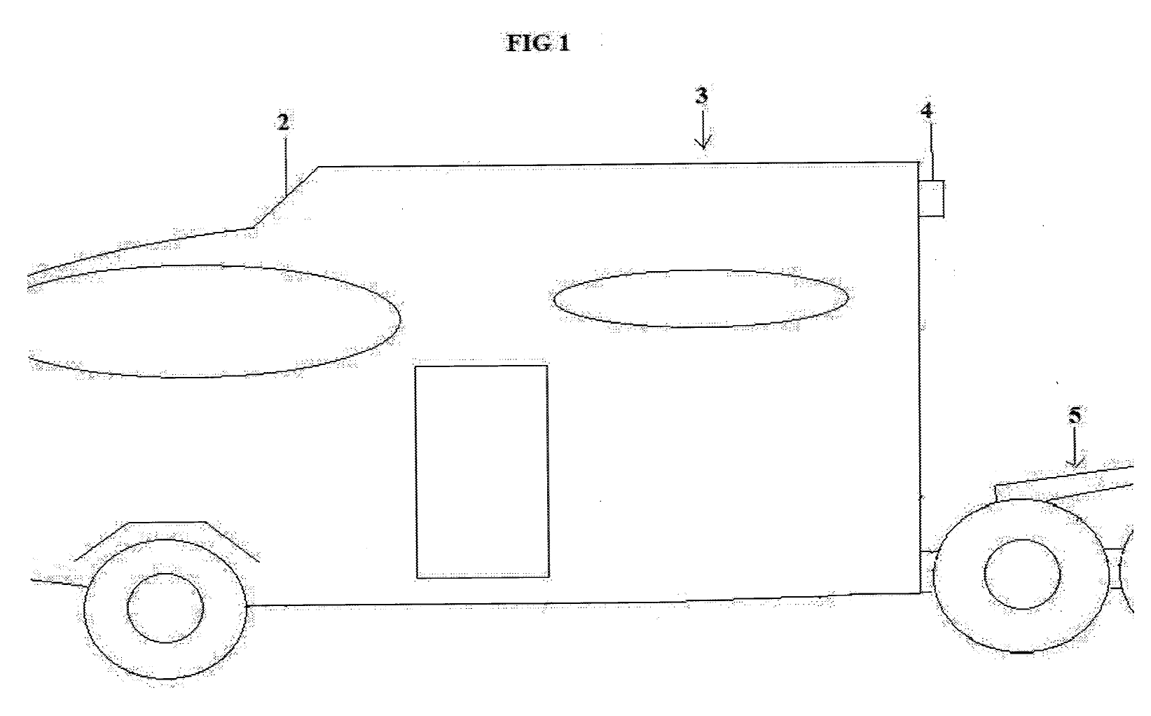

FIG. 1 Depicts the Left side Aerodynamic Design 1, Ram Air Intake 2, ARA-ICT 3, Nozzle 4, Accessory Section 5.

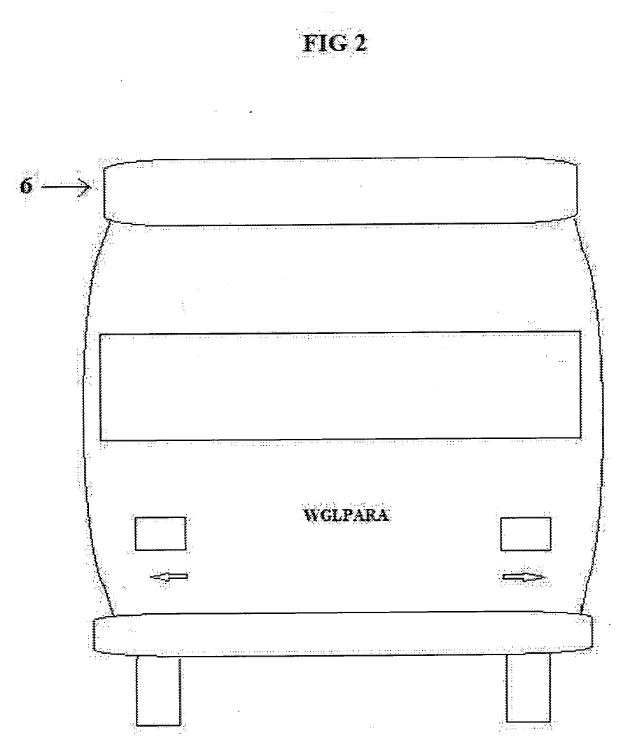

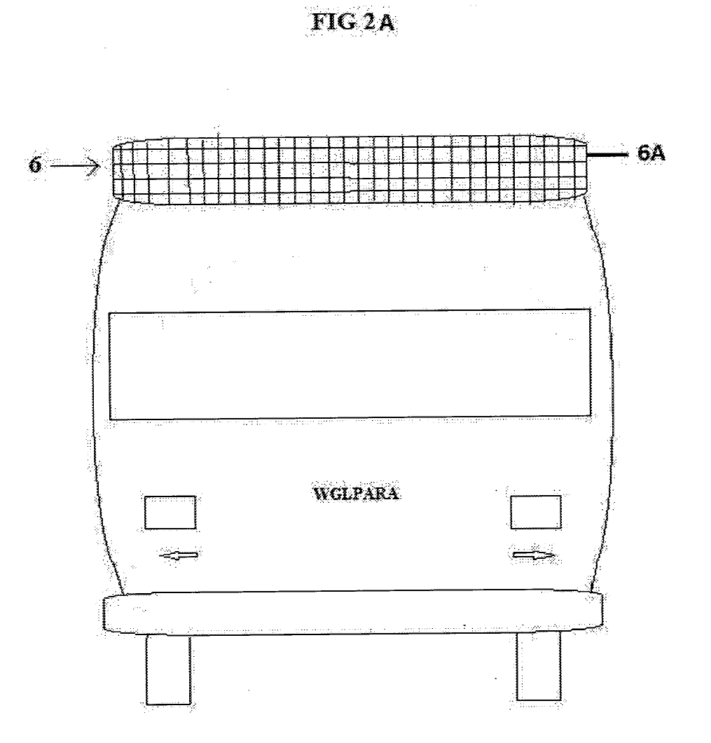

FIG. 2 Depicts the front of the Vehicle and the front Ram Air Intake 6.

### ARA-ICT Description

ARA-ICT stands for Accelerated Ram Air—Intake, Compression, and Thrust.

Is made of three integrated sections: 1. Intake 2. Compression 3. Thrust.

The working principle and source of power is based on the Bernoulli's principle (an increase in the speed of a fluid occurs simultaneously with a decrease in pressure or a decrease in the fluid's potential energy . . . ) and Newton's 2^{nd} (the rate of change of momentum of a body, is directly proportional to the force applied and this change in momentum takes place in the direction of the applied force) and 3^{rd} Laws (all forces between two objects exist in equal magnitude and opposite direction).

The ARA-ICT uses the vehicle's forward motion to intake the required Ram Air, then compresses as required the Ram air, and finally generates the required Thrust. The ARA cannot produce thrust at zero speed; consequently, it cannot move a vehicle from a standstill.

The ARA-ICT can be integrated with any vehicle that have the required area like semi-trucks, buses, motorhomes, trains, boats, and airplanes where it can be legally installed.

The ARA-ICT will be built using a combination of Carbon Fibers, Glass Fibers, Plastic Fibers, Steel, Aluminum, Titanium, Kevlar, and other required materials.

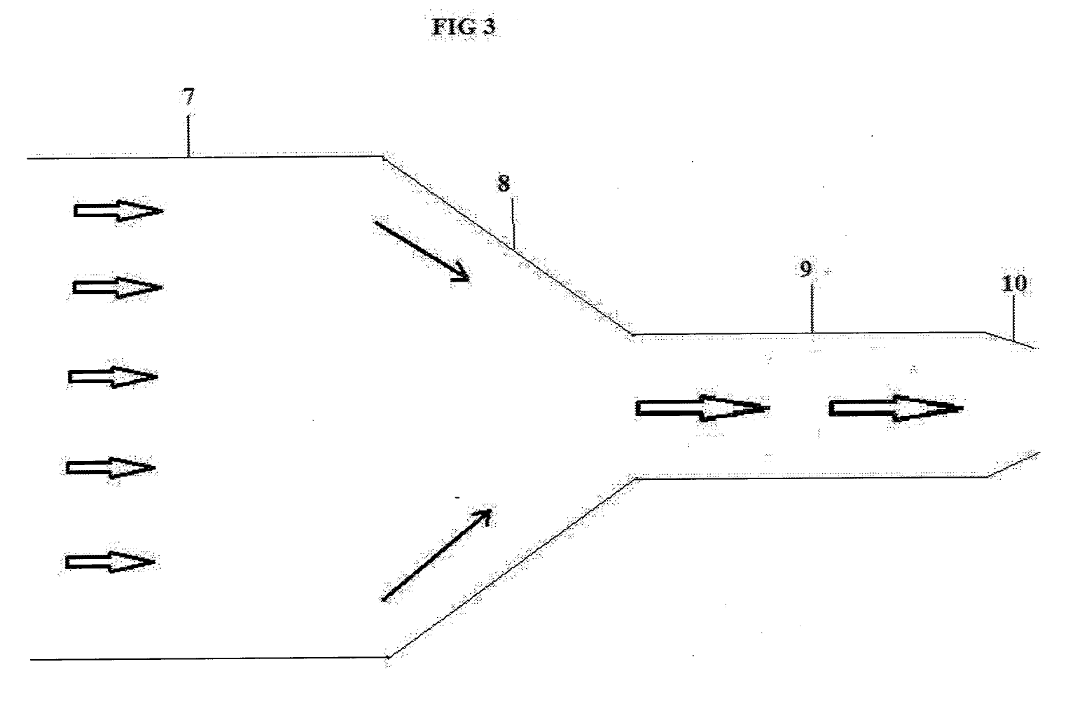

FIG. 3 Depicts the ARA-ICT Sections Intake 7, Compression 8, Thrust 9, and Nozzle 10.

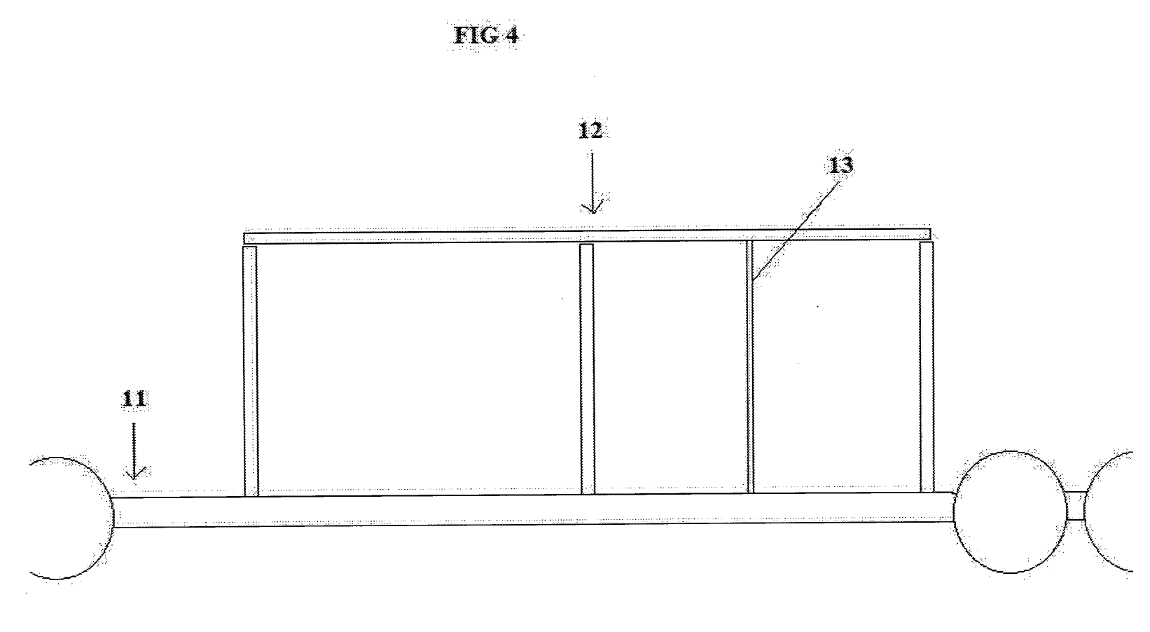

FIG. 4 Depicts the Main Chassis (Rolling Chassis) 11, Supports (Sub-frames) for the ARA-ICT and WGLPP 12, and WGLPP Firewall Support 13.

### Internal Description

Based on the Body-on-Frame construction, the interior will be divided in four sections:

1. Control Section. 2. Sleeping Section. 3. WGLPP Section. 4. Accessories and Interface Section:

Control Section: contains all the systems that control the WGLPP, the ARA-ICT, and all the vehicle operation, safety, and comfort interfaces. Sleeping Section: Allocates the required beds, cooling and heating, water supply, communications, and entertainment systems.

WGLPP Section: Contains the Mobile power plant, battery, and the propulsion system.

Accessories and Interface Section: Contains all the required accessories and interfaces like the Fifth-Wheel coupling.

Materials used: The interior will be built using Carbon Fibers, Glass Fibers, Plastic Fibers, Steel, Aluminum, Titanium, Kevlar, and other required materials.

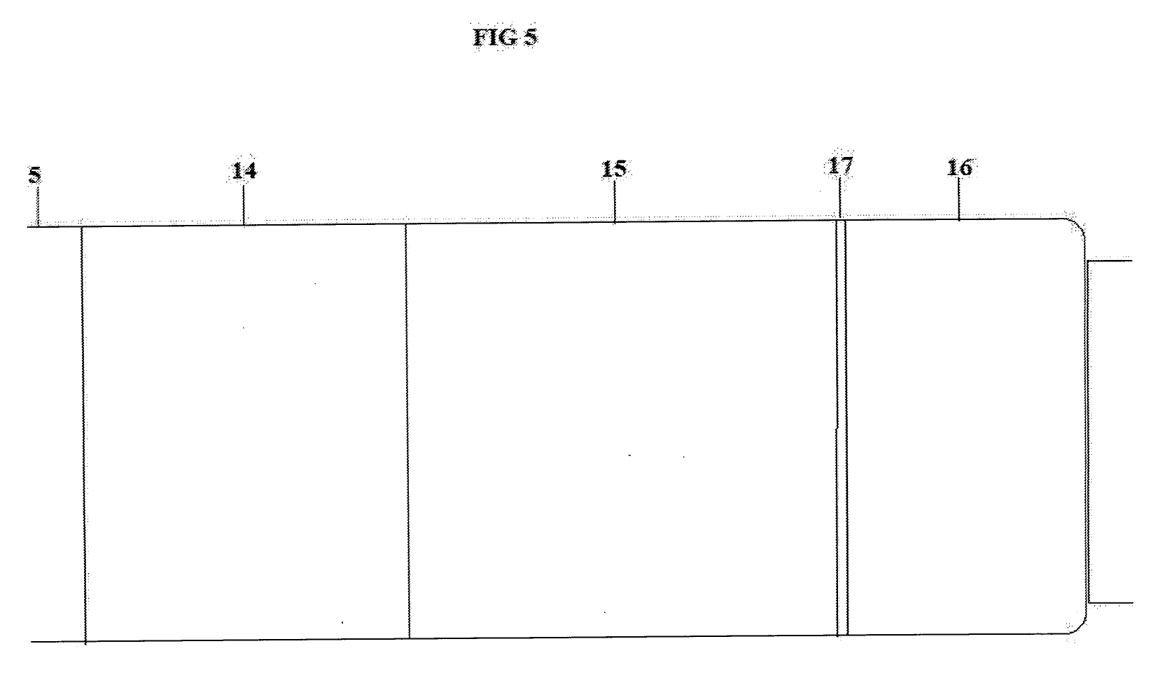

FIG. 5 Depicts the Interior Layout. Control Section 14, Sleeping Section 15, WGLPP Section 16, Accessories and Interface Sections 5, and WGLPP Firewall 17.

### How to Build the Vehicle

1. Determine the requirements for the specific purpose and capacity of the Vehicle.
2. Build the Chassis (Rolling Chassis) and Sub-frames that will support the body.
3. Build the Body
4. Build the Interior
5. Build all the accessories—Test Accessories
6. Install the Interior, the Accessories, and the Body on the Chassis.
7. Finish the Vehicle integration and perform all required test to comply with applicable laws.
8. Operate as approved by Certification Authority.

1. A self-powered, highly efficient, heavy duty, continuous operation, sustainable, and renewable energy Transportation Electric Vehicle, that is primarily propelled by electric motors that are powered by the Water Gravity Loop Power Plant (WGLPP), U.S. Pat. No. 9,677,536 B2, and secondarily propelled by the Accelerated Ram Air—Intake, Compression, and Thrust (ARA-ICT) propulsion system;
A Water Gravity Loop Power ARA EV (WGLPARAEV) Rolling Chassis comprising the Water Gravity Loop Power Plant (WGLPP) and its Vehicle propulsion system as described in claim 2;
An ARA-ICT propulsion system comprising an Intake Section, a Compression Section, and a Thrust Section comprising a nozzle to control the amount of thrust and to control the direction of the thrust as required by the Vehicle performance and control;
A Ram Air Intake designed to maximize the intake of Ram Air and located at a point of maximum Ram Air Intake and its shape and size built based on the Vehicle thrust requirements;
A first volume of Ram Air generated by the forward movement of the Vehicle and flowing into the required shape and size Ram Air Intake Section, and continue flowing to the Compression Section where the Ram Air is compressed at the required compression rate, and finally flowing to the required shape and size Acceleration Section where the Ram Air is accelerated to generate the required thrust;
The ARA-ICT equipped with protection system to prevent ice formation and foreign objects entry and a system to remove ice accumulation at the Intake Section;
An aerodynamically efficient exterior design that minimizes drag, minimizes lift, and maximizes the intake of Ram Air that will be compressed by the ARA-ICT to generate propelling thrust.

2. The Accelerated Ram Air—Intake, Compression, and Thrust (ARA-ICT) propulsion system of claim 1, further comprising:
A compliant ARA-ICT to be integrated and operated based on the requirements of any Vehicle on the ground (Semi-trailers, Rail Transportation Vehicles, Industrial Vehicles, Cars . . . ), any Vehicle on the water surface (Watercrafts . . . ), and any Vehicle flying in the air (Aircraft . . . ).

3. The Accelerated Ram Air—Intake, Compression, and Thrust (ARA-ICT) propulsion system of claim 1, further comprising:
A compliant Liquid-ICT to be integrated and operated based on the requirements of any Vehicle under the water surface (Submersible Watercrafts, Underwater Vehicles);
A first volume of accelerated liquid generated by the forward movement of the Vehicle and flowing into the required shape and size Intake Section, and continue flowing to the Compression Section where the liquid is compressed at the required compression rate, and finally flowing to the required shape and size Acceleration Section where the liquid is accelerated to generate the required thrust.
